(19) United States
(12) Patent Application Publication
(10) Pub. No.: US 2022/0237633 A1
(43) Pub. Date: Jul. 28, 2022

(54) AUTOMATICALLY UPDATING USER INTERFACES WITH DISPARATE REAL-TIME DATA SOURCES

(71) Applicant: CandidApp LLC, Brentwood, TN (US)

(72) Inventor: Garrett Blair Locklear, Nashville, TN (US)

(21) Appl. No.: 17/365,865

(22) Filed: Jul. 1, 2021

Related U.S. Application Data
(60) Provisional application No. 63/141,797, filed on Jan. 26, 2021.

(51) Int. Cl. G06Q 30/02; G06Q 30/06; G06Q 40/02; G06N 20/00

(52) U.S. Cl. CPC G06Q 30/0201; G06Q 30/0623; G06N 20/00; G06Q 30/0239; G06Q 40/025

(57) ABSTRACT

A system, method, and computer-readable medium are disclosed for automatically updating graphical user interfaces when data is received and updated from multiple sources of different types. An update of a dataset in a static data source may be detected by the system, which may trigger a request to a data feed for an updated dataset. Based on the data in the updated datasets, the system may automatically update the graphical user interface. The system may determine that the updated data matches a product within a product feed and send out a notification to a user regarding the match.

### CROSS-REFERENCE TO RELATED APPLICATIONS

This application claims the benefit of U.S. Provisional Patent Application No. 63/141,797, filed Jan. 26, 2021, which is incorporated by reference.

### TECHNICAL FIELD

The disclosure relates generally to user interfaces and, in particular, to automatically updating information for display using data received from disparate data sources.

### BACKGROUND

As data continues to grow as exponential scale, it continues to be challenging to process that data in a manner that is actionable and insightful. Further, once data is processed, conveying meaning in a manner that is readily consumable by those interacting with computing systems also is challenging. Information derived from data is often displayed within a graphical user interface (GUI). GUIs are used for a variety of functions, including displaying information, providing user interaction with applications, and enabling data analysis, etc.

GUIs may ingest data from static sources (e.g., databases) and non-static sources (e.g., data feeds). However, automatically refreshing such GUIs quickly when data changes in one type of source with updated data from a different type of source may be difficult. For example, due to the disparate nature of data sources (e.g., data may be housed at multiple unrelated entities or have no common format), multiple user interfaces may be required to traverse these sources to obtain data, aggregate received data, and then separately derive meaningful information from the aggregated data. This may consume unnecessary computing resources due to further processing, such as displaying data within the different user interfaces and requiring the user to toggle between two or more interfaces to analyze the data. Moreover, the data displayed within those interfaces may include data that is unnecessary for the task the user is performing yet took processing time and resources to process and display.

### BRIEF DESCRIPTION OF DRAWINGS

The disclosed embodiments have advantages and features which will be more readily apparent from the detailed description, the appended claims, and the accompanying figures (or drawings). A brief introduction of the figures is below.

Figure (FIG. 1 is a block diagram of a networked computing environment suitable for automatically providing updated information for display using data received from multiple (i.e., two or more) data sources, according to one embodiment.

FIG. 2 is a block diagram of the display node if FIG. 1, according to one embodiment.

FIGS. 3A through 3D illustrate an example GUI, according to one embodiment.

FIG. 4 is a flowchart illustrating a method for automatically updating a GUI with data received from multiple data sources and identifying a match between a user and a product, according to one embodiment.

FIG. 5 is a block diagram illustrating components of an example machine able to read instructions from a machine-readable medium and execute them in a processor (or controller).

### DETAILED DESCRIPTION

The Figures (FIGS.) and the following description describe certain embodiments by way of illustration only. One skilled in the art will readily recognize from the following description that alternative embodiments of the structures and methods may be employed without departing from the principles described. Wherever practicable, similar or like reference numbers are used in the figures to indicate similar or like functionality.

Configuration Overview

A system (and corresponding method and computer-readable storage medium) enable provision of a GUI to a user that includes information derived from multiple data sources. In various embodiments, the data sources are updated over different time scales and/or use different data formats. For example, a first data source may update data in a first format approximately hourly, daily, weekly, etc., while a second data source may update data in a second format approximately monthly or annually, etc. Note that although specific timescales, such as daily or weekly, are identified, this should not be construed as requiring periodic updates. Rather, this may be indicative of the typical length of time between updates. For example, a data source described as being updated weekly may be updated on a given day, then updated again six days later, and then a third time eight days after that, etc.

The system may aggregate and process the data received from the data sources to generate information for display in a GUI. Processing the data may include calculating new data from received data. For example, in an embodiment where the GUI provides information about home loans, the system may use a historical valuation of a property and data regarding general changes in property prices since the historical valuation was made to predict a current valuation.

The system may associate received data and/or information derived from received data with user accounts. The data and/or information associated with user accounts may be compared to product offerings to determine whether the corresponding users are eligible for and/or are likely to be interested in the product offerings. If a user is matched with a product offering (e.g., the user if eligible for a product offering or is predicted to have a high likelihood of being interested in the product offering) then the system may initiate a process to inform the user of the product offering. For example, in an embodiment relating to home loans, if the system determine that a homeowner may reduce their monthly mortgage payments with a refinancing product offering, a GUI displayed to a loan officer may be automatically updated with a notification suggesting the homeowner is contacted. Additionally or alternatively, the homeowner may automatically be contacted directly (e.g., via an email, instant message, text message, or the like).

In one embodiment, the system determines which users to recommend for or provide with a product offering using a two-stage algorithm. First, the system uses a coarse filter to identify a set of users that are likely to be eligible and/or interested in the product offering. Second, the system performs a more detailed analysis of data associated with the set of users to identify a subset to recommend for the product offering. Use of the two-stage approach may enable efficient use of computing resources, particularly where there are a sufficiently large number of users that performing the more detailed analysis for every user would be impractical.

Example Computing Environment

Figure (FIG. 1 illustrates one embodiment of a networked computing environment 100 suitable for automatically providing updated information for display using data received from multiple data sources. In the embodiment shown, the networked computing environment includes a display node 110, a storage node 120, and a data feed node 130, all communicatively coupled via a network 170. In other embodiments, the networked computing environment 100 includes different and/or additional elements. In addition, the functions may be distributed among the elements in a different manner than described. For example, although FIG. 1 only shows a single storage node 120 and a single data feed node 123, the networked computing environment may include any number of each type of node.

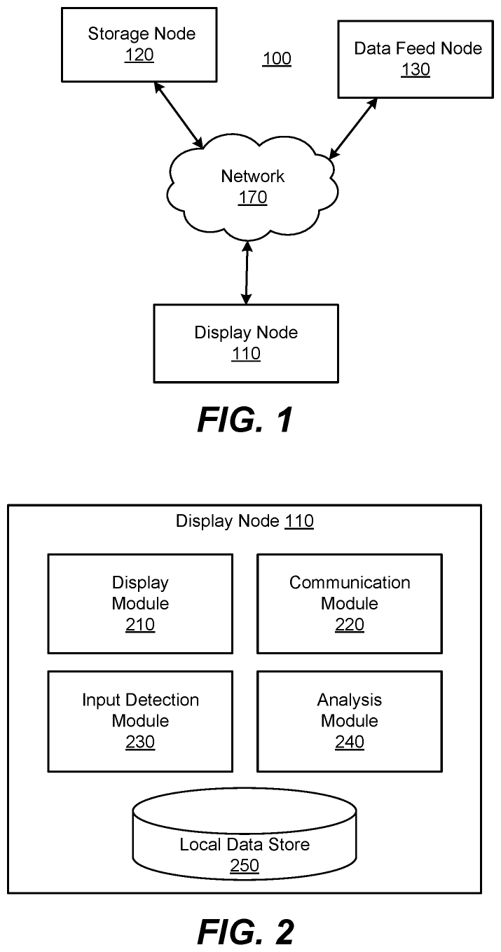

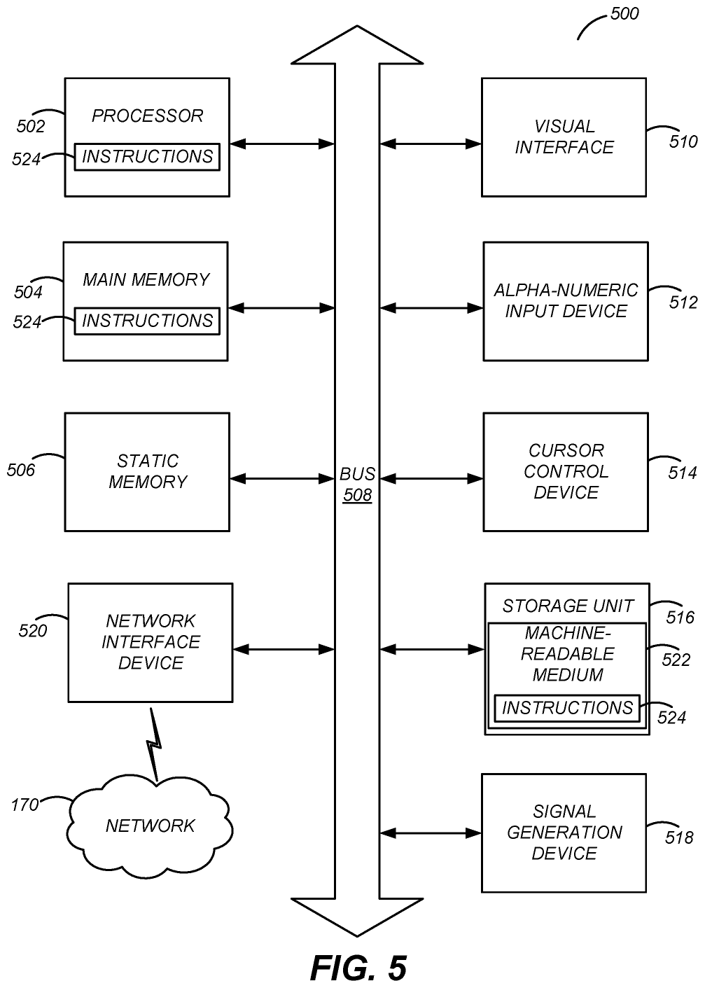

A display node 110, storage node 120, or data feed node 130 includes may be one or more computing devices (e.g., with components illustrated in FIG. 5). A display node 110 may be configured to receive data from one or more storage nodes 120 and/or one or more data feed nodes 130. In one embodiment, the display node 110 processes the received data and automatically updates a GUI using information derived from the received data. The display node 110 may also analyze the received data to identify one or more product offerings to recommend for a user. The identified product offerings may be indicated in the GUI and/or communicated directly to the user (e.g., via email, instant message, or text message, etc.). Various embodiments of the display node 110 are described in greater detail below, with reference to FIG. 2.

A storage node 120 generally stores static data that may be accessed and/or pushed to the display node 110 under specified conditions (e.g., periodically, if a threshold condition is met, or on request from a user, etc.). The term “static data” is used herein to mean data that is not updated regularly or periodically. For example, static data may be updated when a change to the data is needed or made available, such as when a user fills out a home assessment. In one embodiment, the storage node 120 stores static data in a database.

In contrast, a data feed node 130 generally provides dynamic data, such as data that is updated at a regular interval (e.g., every five seconds, ten seconds, one minute, or another suitable interval). In one embodiment, the data feed node 130 sends feed data to the display node 110 as it is updated. Thus, the amount of data provided to the display node 110 from the feed node 130 can be very large.

The display node 110 may receive both static and dynamic data and use it to automatically update user interfaces. Note that although storage nodes 120 and data feed nodes 130 are described herein as separate entities, some nodes may function as both a storage node and a data feed node. For example, a single computing device operated by a financial institution may provide dynamic data (e.g., current interest rates available) and static data (e.g., information about a homeowner, such as employment status, family size, and current home loan interest rate, etc.).

The network 170 provides the communication channels via which the other elements of the networked computing environment 100 communicate. The network 170 can include any combination of local area and/or wide area networks, using both wired and/or wireless communication systems. In one embodiment, the network 170 uses standard communications technologies and/or protocols. For example, the network 170 can include communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 170 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 170 may be represented using any suitable format, such as hypertext markup language (HTML) or extensible markup language (XML). In some embodiments, all or some of the communication links of the network 170 may be encrypted using any suitable technique or techniques.

FIG. 2 illustrates one embodiment of the display node 110. In the embodiment shown, the display node 110 includes a display module 210, a communication module 220, an input detection module 230, an analysis module 240, and a local data store 250. In other embodiments, the display node 110 includes different and/or additional elements. In addition, the functions may be distributed among the elements in a different manner than described.

The display module 210 generates for display (e.g., in a graphical user interface), a set of fields displaying information derived from data received from one or more storage nodes 120 and/or data feed nodes 130. In one embodiment, the graphical user interface includes a summary of user data associated with a home of a user. The summary of the user data may be generated based on a first dataset received from a first node (e.g., a storage node 120) and a second dataset received from a second node (e.g., a data feed node 130). One or more fields of the user data may be calculated or otherwise generated using multiple received data items, which may be from the first data set, the second data set, or both.

In some embodiments, the fields in the GUI may be interactive. In response to receiving a user selection of a field, display module 210 may cause the GUI to be updated to display the data used to calculate the value initially displayed in the field. The data used to calculate the value may replace the value (e.g., to make efficient use of display real estate within the GUI) or be displayed in conjunction with the value. For example, if a user rolls a mouse cursor over a specific field, the input detection module 230 may detect an area of the GUI where the selection has taken place and determine that the specific field has been selected. The input detection module 230 may pass a field identifier of the specific field to the display module 210. The display module 210 may provide for display the data from one or more nodes that was used to calculate the value displayed in the specific field. In some embodiments, the data used for calculating the value displayed in the field includes a formula used to calculate the value. Thus, when a user selects (e.g., clicks on or rolls over the specific field with a mouse) a given field, the display module 210 may display the data values used to generate the value initially displayed in the field plugged into a formula used for generating the initially displayed value.

The communication module 220 may be configured to receive data from one or more storage nodes 120 and/or one or more data feed nodes 130. The communication module 220 may pass the received data to analysis module 240. In one embodiment, the communication module 220 does not process data received from data feed nodes 130 until instructed to by the analysis module 240. The communication module 220 monitors for data received from storage nodes 120 and passes such data updates to the analysis module 240. The communication module 220 may periodically query a storage node 120 for new data and/or passively listen for new data pushed to the display node 110 by the storage node 120. For example, if a storage node 120 stores relatively static data, the storage node may be configured to push updated data to the display node 110 whenever the data it stores is updated.

The analysis module 240 may analyze the received data to determine whether a dataset used by the GUI has been updated to form an updated dataset. For example, the analysis module 240 may access the received data and determine that the received data includes a flag indicating an update to the data has occurred (e.g., an update to database data) and/or compare the received data to a previously received version of the data (e.g., stored in the local data store 250). In response to detecting that the dataset has been updated, the analysis module 240 may access a data feed (e.g., being streamed by a data feed node 130) to access additional updated data. For example, if analysis module 240 detects that the data associated with a user's home in the database has been updated, analysis module 240 may generate a command to receive current interest rate and valuation data from a data feed node 130. That is, analysis module 240 may pass a command to the communication module 220, which may have been receiving data from the data feed node 130 but ignoring the data or otherwise not processing the data. When communication module 220 receives the updated data from the data feed node 130, the communication module may save the updated data (e.g., in the local data store 250) and/or pass the updated data to the analysis module 240. In this way, the analysis module 240 may enable efficient use of computational resources because the communication module 220 does not process the potentially large volume of data received from the data feed node 130 until updated data is received from the storage node 120.

The interaction between the communication module 220 and the analysis module 240 may identify a first updated dataset (received from a storage node 120) and a second updated dataset (received from data feed node 130). One of skill in the art that any number of updated datasets may be received from any number of nodes using this approach. For example, on receiving an updated dataset from a first storage node 120, the analysis module 240 may send a command to the communication module 220 to retrieve an updated dataset from a second storage node and extract additional updated sets from data feeds being streamed from multiple data feed nodes 130.

Regardless of the number of updated datasets received, the analysis module 240 may generate updated user data based on the updated datasets. For example, the analysis module 240 may update a previously stored version of first dataset with updated data received from a storage node 120 and update a previously stored version of a second dataset with updated data from a data feed node 130. In addition, the analysis module 240 may use the updated first dataset and the updated second dataset to automatically recalculate user data, generating updated user data. The analysis module 240 may pass the updated user data to the display module 210, which may update one or more fields in the GUI to reflect the updated user data. That is, the GUI may be automatically updated to reflect the newly generated user data when the underlying datasets are updated.

The communication module 220 may also receive a product feed (e.g., from a data feed node 130). The product feed may include information about different financial products (e.g., home refinance products) that are available from various sources. The communication module 220 may receive the financial product data from the data feed and pass the product data to the analysis module 240. The analysis module 240 may determine, based on the updated user data and the financial product data, that one or more attributes of a product match one or more attributes of the updated user data. For example, one or more fields of the updated user data may be compared with data associated with each available product to determine whether there is a match. For the example, a match between a product and a user may be fund if one or more specified fields within the user data fall within a range of values specified for the product in the product data. Thus, analysis module 240 may identify, based on the comparing, the product within the product data feed with attributes that match attributes of the updated user data.

In various embodiments, the analysis module 240 may periodically (e.g., weekly), on request from an operator (e.g., an employee of a financial product provider), or in response to another triggering event (e.g., receiving updated data, one or more values in updated data changing by more than a threshold amount, or one or more values in updated data having values above and/or below corresponding thresholds, etc.) identify one or more users to offer a financial product. For example, the analysis module 240 may maintain a database (e.g., in the local data store 250) of users with home loans and offer a subset of those users one or more options for refinancing their home loans. The subset may include all users who meet specified criteria or a predetermined number of users (e.g., fifty, one hundred, two hundred, etc.) that the analysis module 240 determines are most likely to accept an offer to refinance their home loan.

In one embodiment, the analysis module 240 uses a two-stage algorithm to identify the subset of users to be offered refinancing option for their home loan. In the first stage, applies one or more filters to reduce the number of users considered in the second stage. For example, the analysis module 240 may calculate the difference between a user's current interest rate and the interest rates currently available in the market and only consider the user in the second stage if the difference exceed a threshold (e.g., one percent). As another example, the analysis module 240 may calculate the ratio between the user's current loan balance and an estimated (or appraised) value of the user's home and not consider user's in the second stage for whom the ratio exceeds a threshold. It should be appreciated that many combinations of metrics and thresholds may be used to quickly (and computationally cheaply) reduce the number of users considered in the second stage to a manageable number, regardless of the total number of users in the database.

In the second stage, the analysis module 240 may apply more complex (and computationally expensive) analysis of the set of users identified in the first stage to identify a subset of users to offer a refinancing option. The analysis module 240 may use business rules, a machine learning model, or a mixture of both applied to the user data and product data to calculate a likelihood that a given user will accept a given refinance offer. The analysis can include both quantitative factors (e.g., current loan balance, interest rate, monthly payments, potential monthly savings, potential lifetime savings, etc.) and qualitative factors (e.g., recent job changes, recent family events, and self-identified goals, etc.). The analysis can incorporate information provided as part of an annual mortgage review. The output of the second stage may be a subset of users matched with corresponding financial products.

In embodiments that use a machine learning model, the model may be trained using the display node 110 or a separate computing system. The model may be trained using supervised or semi-supervised learning. Example models include neural networks, decision trees, support vector machines, linear regressions, and the like. The model is trained by identifying a training data set that is labelled. For example, information about users for a preceding time period (e.g., the last month) may be labeled to indicate which of one or more financial products (if any) the user used. Thus, the training data includes positive examples for one or more financial products (user data of users that used each of the financial products) and negative examples for one or more financial products (users that did not use the financial product. A given user can be a positive example for one product and a negative example for another product. The labels may be applied manually by an operator or automatically by a computing system (e.g., by cross-referencing the user data with sales data indicating financial products used by the users).

Regardless of how the training data is generated, the model is applied to the training data to predict whether each user will make use of one or more financial products. The prediction may be binary yes/no value or a value indicating a likelihood that the user will use the corresponding product (e.g., a probability percentage). A cost value is calculated from the model output using a cost function. To give a simple example, if the predictions are binary values indicating whether a user will use a financial product, the cost might be the number of false positives (instances of users being predicted to use a product that did not use the product) plus the number of false negatives (instances of users being predicted to not use the product that did use the product). One of skill in the art will recognize that a wide range of cost functions may be used to calculate a cost value using the output from the model.

One or more parameters of the model may be updated based on the cost value. A backpropagation algorithm may be used to determine how to update one or more parameters to reduce (or increase) the cost value. The process of applying the model to labelled training data, calculating a cost value, and updating the model parameters may be iterated until an end condition is met. Example end conditions include a predetermined number of iterations, the cost value reducing below a threshold (or increasing above a threshold), or the cost value changing by a threshold percentage, etc. The trained model may be applied to an additional set of training data (referred to as validation data) to validate that the model has not been overfitted to the training data and may make accurate predictions on generalized input data.

When a matching product is identified (using matching rules, the trained machine learning model, or both), the analysis module 240 may generate a message for the user describing the matching product. The message may include the portion of the updated user data and the portion of the updated product data. The analysis module 240 may pass the message to the communication module 220. The communication module 220 may transmit the message to a user either automatically or after confirmation by an authorized individual (e.g., an employee of the company offering the matching product). The message may be transmitted using email, instant message, or any other suitable medium.

In some embodiments, the analysis module 240 may pass at least a portion of the message to display module 210 to be displayed in the GUI. The display module 210 may update the GUI to include an identifier of the message. In some embodiments, in response to a selection of the identifier of the message, the display module 210 may generate for display in the GUI, a portion of the data associated with the product and a portion of the updated user data. For example, the input detection module 230 may detect an area associated with the displayed indicator of the message to be selected (e.g., by a click of a mouse or a roll over with a mouse). When the detection occurs, the input detection module 230 may pass an identifier of the detected field to the display module 210. In response, the display module 210 may generate for display at least a portion of the data associated with the product and at least a portion of the updated user data.

In some embodiments, the analysis module 240 gathers offer success data indicating whether messages are authorized to be sent to the corresponding users and/or how the users engage with the messages (e.g., whether a user reads a message, responds to message, or makes use of the financial product identified in the message). In one embodiment, the analysis module 240 retrains the model using some or all of the original training data and/or the offer success data. The model may be retrained periodically (e.g., daily, weekly, etc.) or on demand from an operator (e.g., an administrator). In this way, the model may be efficiently updated with little or no human intervention to reflect the latest user behavior in view of external factors such as market conditions, competing products, economic outlook, and the like.

Example GUI

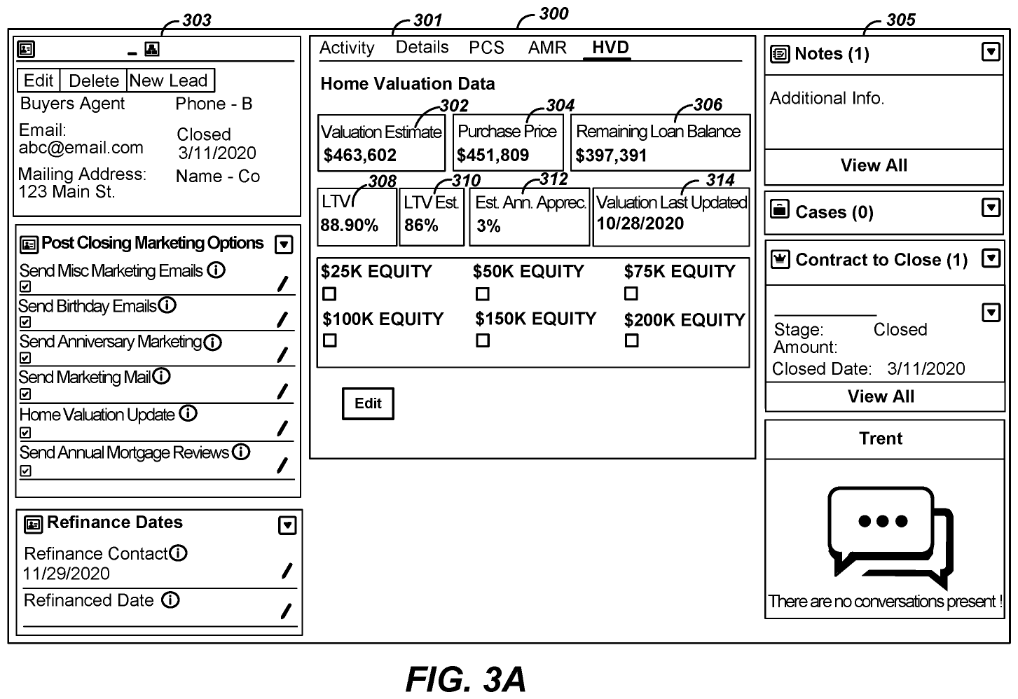

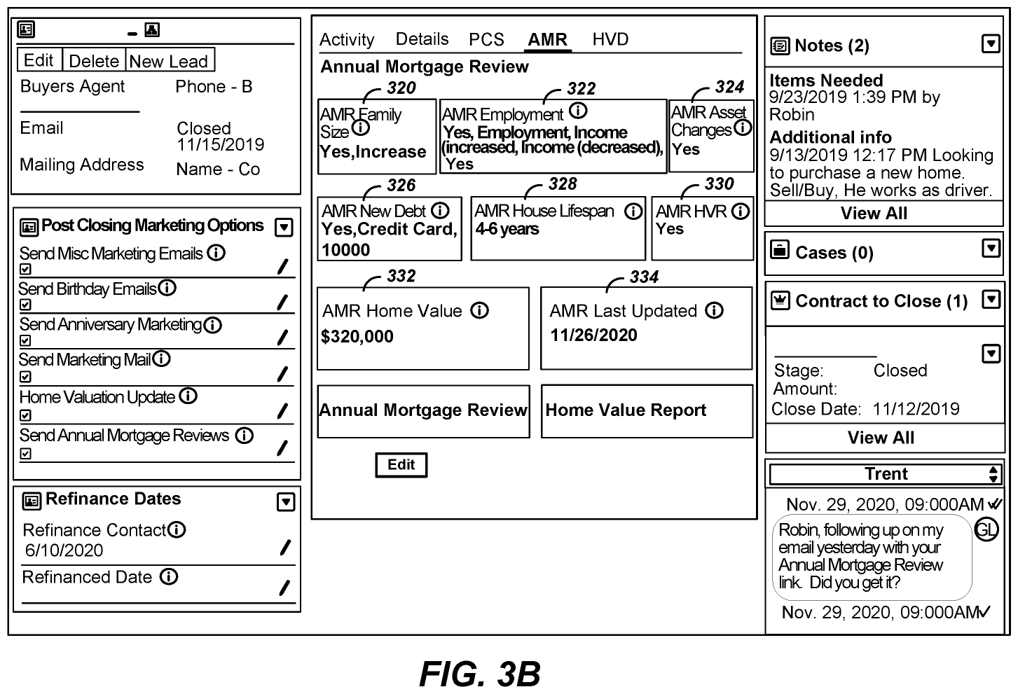

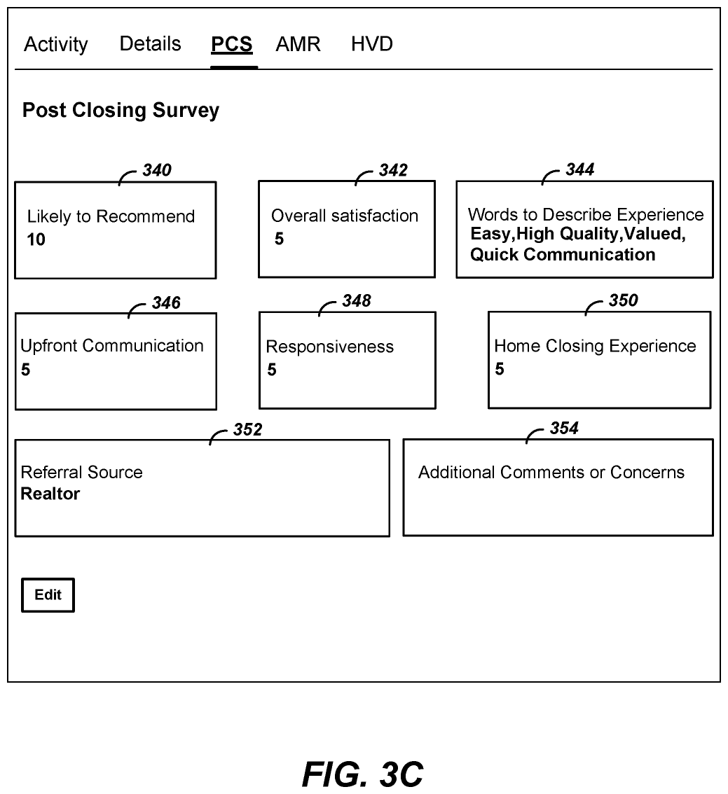

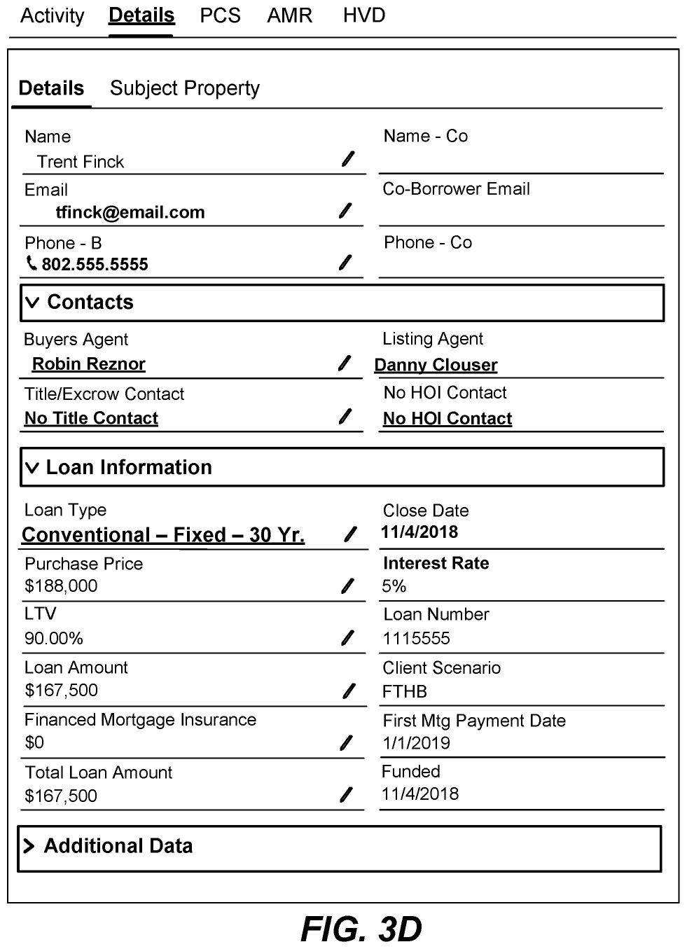

FIGS. 3A through 3D illustrate a possible GUI, according to one embodiment. The GUI may include fields obtained and/or derived from a static data source and a data feed. Specifically, FIGS. 3A through 3D show an example GUI for displaying home valuation and loan information of a user. The information in the GUI may be used to ascertain the status of a specific user's loan and home valuation status. The GUI includes a central portion 300 with a set of navigation tabs 301 and additional portions 303, 305 on either side for additional information and/or controls. For example, the left portion 303 may include information about a current product offering for the user (e.g., as recommended by the analysis module 240) and controls for an operator to select post-closing marketing preferences. As another example, the right portion 305 may include an rea for the operator to take notes, view information about any on-going cases or refinance contracts, and/or communicate with the user.

In FIG. 3A, the central portion 300 has the home valuation data (HVD) tab selected and the user's HVD is displayed. The HVD may include multiple fields, which may be automatically updated as new user data is received from a storage node 120 and/or a data feed node 130. Specifically, in the embodiment shown in FIG. 3A, the HVD includes fields for: a valuation estimate 302, a purchase price 304, a remaining loan balance 306, a loan-to-valuation (LTV) ratio 308, a LTV estimate 310, an estimate of annual appreciation 312, and a date on which the valuation was last updated 314.

In FIG. 3B, the Annual Mortgage Review (AMR) tab is selected and the user's most recent AMR answers are displayed. As with the HVD, the user's AMR answers may be automatically updated as new data is received. The user's AMR answers may be combined with data received regarding the home value of the user. Some of the information displayed in the AMR tab may be received from a user and stored in a database (e.g., the local data store 250 or a storage node 120) while other data may be part of a feed that is received (e.g., from a data feed node 130). Specifically, in the embodiment shown in FIG. 3B, the information displayed in the AMR tab includes fields for: whether the user's family size has changed 320, whether the user's employment status has changed 322, whether the user has other asset changes 324, whether the user has new debt 326, the user's expected house lifespan 328, whether the user has elected to receive a periodic (e.g., annual) home value report (HVR) 330, the user's home value 332, and the date of the last update to the user's AMR 334.

In FIG. 3C, the Post Closing Survey (PCS) tab is selected and the results of a survey completed by the user after closing on their home regarding the financial institution that provided their home loan. In the embodiment shown in FIG. 3C, the information displayed in the PCR tab includes fields for: a likelihood that the user would recommend the financial institution to another 340, an overall satisfaction score for the financial institution 342, a set of words provided by the user describing the experience 344, a rating for upfront communication of the financial institution 346, a rating for responsiveness of the financial institution 348, a rating for the closing experience 350, the referral source 352, and any additional comments or concerns 354.

In FIG. 3D, the Details tab is selected and details of the user and their loan are displayed, such as the user's name, email address, phone number, other contacts, loan number, type of loan, home purchase price, remaining loan balance, LTV ratio, etc. The GUI also includes a control for the operator to access information about the property purchased with the loan. Thus, the operator can quickly and easily access any desired information about the user and loan.

Example Method

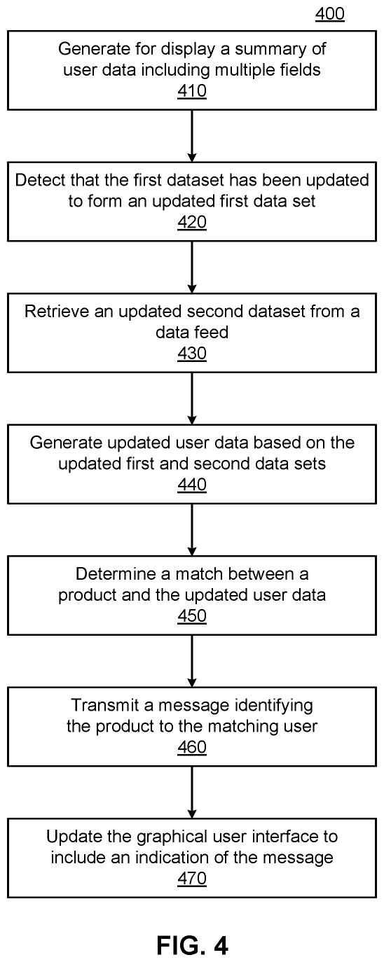

FIG. 4 is a flowchart of an example method 400 for automatically updating a GUI with data received from multiple data sources and identifying a match between a user and a product, according to one embodiment. The steps of FIG. 4 are illustrated from the perspective of the display node 110 performing the method 400. However, some or all of the steps may be performed by other entities or components. In addition, some embodiments may perform the steps in parallel, perform the steps in different orders, or perform different steps.

In the embodiment shown in FIG. 4, the method 400 begins with the display node 110 generating 410 a summary of user data for display. The summary may include multiple fields. The fields may be derived or otherwise obtained from a first dataset (e.g., static data received from a storage node 120) and a second dataset (e.g., dynamic data received from a data feed node 130).

The display node 110 detects 420 that the first dataset has been updated. In response to the first dataset having been updated, the display node 110 retrieves 430 an updated version of the second dataset (e.g., from a data feed node 130). In some embodiments, the display node 110 is sent updated data for the second dataset in a feed as it is generated but the display node ignores or otherwise does not process the updated data for the second dataset until an update to the first dataset is detected 420.

The display node 110 generates 440 updated user data using the updated first and second datasets. The display node 10 may update the GUI to include a summary of the updated user data. The summary of the updated user data may include multiple fields derived or otherwise obtained from the updated user data. The display node 110 determines 450 a match between a product and the updated user data. For example, the display node 110 may receive product data from a product data feed and identify a match between one or more attributes of a product in the product data with one or more attributes in the updated user data.

The display node 110 transmits 460 a message identifying the product to the matching user. The message may be transmitted as an email, instant message, or any other suitable type of message. The display node 110 updates 470 the GUI to include an indication of the message. For example, the GUI may include an identifier of the message, a summary of the message, or the complete message, etc.

Computing Machine Architecture

FIG. 5 is a block diagram illustrating components of an example machine able to read instructions from a machine-readable medium and execute them in a processor (or controller). Specifically, FIG. 5 shows a diagrammatic representation of a machine in the example form of a computer system 500 within which program code (e.g., software) for causing the machine to perform any one or more of the methodologies discussed herein may be executed. The program code may be comprised of instructions 524 executable by one or more processors 502. While processor 502 is shown in an example embodiment to be a single processor, the term “processor” should be taken to include a single processor or multiple processors (including multiple processors distributed between multiple devices coupled via a network). In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 524 (sequential or otherwise) that specify actions to be taken by that machine. Further, while only a single machine is illustrated, the term “machine” shall also be taken to include any collection of machines that individually or jointly execute instructions 524 to perform any one or more of the methodologies discussed herein.

The example computer system 500 includes a processor 502 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 504, and a static memory 506, which are configured to communicate with each other via a bus 508. The computer system 500 may further include visual display interface 510. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 510 may include or may interface with a touch enabled screen. The computer system 500 may also include alphanumeric input device 512 (e.g., a keyboard or touch screen keyboard), a cursor control device 514 (e.g., a mouse, a trackball, a joystick, a motion sensor, or other pointing instrument), a storage unit 516, a signal generation device 518 (e.g., a speaker), and a network interface device 520, which also are configured to communicate via the bus 508.

The storage unit 516 includes a machine-readable medium 522 on which is stored instructions 524 (e.g., software) embodying any one or more of the methodologies or functions described herein. The instructions 524 (e.g., software) may also reside, completely or at least partially, within the main memory 504 or within the processor 502 (e.g., within a processor's cache memory) during execution thereof by the computer system 500, the main memory 504 and the processor 502 also constituting machine-readable media. The instructions 524 (e.g., software) may be transmitted or received over a network (e.g., network 170) via the network interface device 520.

While machine-readable medium 522 is shown in an example embodiment to be a single medium, the term “machine-readable medium” should be taken to include a single medium or multiple media (e.g., a centralized or distributed database, or associated caches and servers) able to store instructions (e.g., instructions 524). The term “machine-readable medium” shall also be taken to include any medium that is capable of storing instructions (e.g., instructions 524) for execution by the machine and that cause the machine to perform any one or more of the methodologies disclosed herein. The term “machine-readable medium” includes, but not be limited to, data repositories in the form of solid-state memories, optical media, and magnetic media.

Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Where values are described as “approximate” or “substantially” (or their derivatives), such values should be construed as accurate +/−10% unless another meaning is apparent from the context. From example, “approximately ten” should be understood to mean “in a range from nine to eleven.”

Upon reading this disclosure, those of skill in the art will appreciate still additional alternative structural and functional designs for a system and a process for automatically updating user interfaces through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for automatically updating graphical user interfaces, the method comprising:
generating for display, in a graphical user interface, a plurality of fields providing a summary of user data, wherein the summary of the user data is generated based on a first dataset and a second dataset;
detecting that the first dataset has been updated to form an updated first data set;
in response to detecting that the first dataset has been updated:
retrieving an updated second dataset from a data feed; and
in response to retrieving the updated second dataset, generating updated user data based on the updated first data set and the updated second data set;
generating for display, in the graphical user interface, an updated plurality of fields providing a summary of the updated user data;
determining, based on the updated user data and product data from a product feed, that one or more attributes of a product match one or more attributes of the updated user data;
transmitting a message to a user, the message identifying the product; and
updating the graphical user interface to include an indication of the message.

2. The method of claim 1, wherein determining that the one or more attributes of the product match the one or more attributes of the updated user data comprises:
comparing the updated user data with the product data; and
identifying, based on the comparing, the product within the product data feed with attributes that match attributes of the updated user data.

3. The method of claim 1, wherein the first dataset is retrieved from a database and the second dataset retrieved from a data feed that is periodically updated.

4. The method of claim 1, further comprising, in response to receiving a user selection of a field of the plurality of fields, providing for display data used for calculating a value associated with the field.

5. The method of claim 4, wherein the data used for calculating a value associated with the field comprises a formula for calculating the value.

6. The method of claim 1, further comprising, in response to receiving a selection of the identifier of the message, providing for display in the graphical user interface, at least a portion of the data associated with the product and at least a portion of the updated user data.

7. The method of claim 1, wherein determining that one or more attributes of the product match one or more attributes of the updated user data comprises:
identifying a set of users by filtering the updated user data based on one or more metrics; and
identifying, based on an analysis of user data of the set of users and the product data, a subset of the set of users, the user included in the subset.

8. The method of claim 7, wherein filtering the updated user data comprises at least one of:
comparing a difference between a user's current interest rate and a currently available interest rate to a first threshold; or comparing a ratio between the user's current loan balance and a value of the user's home to a second threshold.

9. The method of claim 7, wherein the analysis of user data of the set of users and the product data uses a machine learning model to calculate a likelihood that a user will accept an offer of a financial product.

10. A non-transitory computer-readable medium comprising instructions that, when executed by a computing system, cause the computing system to:
generate for display, in a graphical user interface, a plurality of fields providing a summary of user data, wherein the summary of the user data is generated based on a first dataset and a second dataset;
detect that the first dataset has been updated to form an updated first data set;
in response to the first dataset having been updated:
retrieve an updated second dataset from a data feed; and
generate updated user data based on the updated first data set and the updated second data set;
generate for display, in the graphical user interface, an updated plurality of fields providing a summary of the updated user data;
determine, based on the updated user data and product data from a product feed, that one or more attributes of a product match one or more attributes of the updated user data;
transmit a message to a user, the message identifying the product; and
update the graphical user interface to include an indication of the message.

11. The non-transitory computer-readable medium of claim 10, wherein the instructions that cause the computing system to determine that the one or more attributes of the product match the one or more attributes of the updated user data comprise instructions that cause the computing system to:
compare the updated user data with the product data; and
identify, based on the comparing, the product within the product data feed with attributes that match attributes of the updated user data.

12. The non-transitory computer-readable medium of claim 10, wherein the first dataset is retrieved from a database and the second dataset retrieved from a data feed that is periodically updated.

13. The non-transitory computer-readable medium of claim 10, further comprising instructions that, when executed by the computing system, cause the computing system to, in response to receiving a user selection of a field of the plurality of fields, provide for display data used to calculate a value associated with the field.

14. The non-transitory computer-readable medium of claim 13, wherein the data used to calculate a value associated with the field comprises a formula used to calculate the value.

15. The non-transitory computer-readable medium of claim 10, further comprising instructions that, when executed by the computing system, cause the computing system to, in response to receiving a selection of the identifier of the message, provide for display in the graphical user interface, at least a portion of the data associated with the product and at least a portion of the updated user data.

16. The non-transitory computer-readable medium of claim 10, wherein the instructions that cause the computing system to determine that one or more attributes of the product match one or more attributes of the updated user data comprise instructions that cause the computing system to:
identify a set of users by filtering the updated user data based on one or more metrics; and
identify, based on an analysis of user data of the set of users and the product data, a subset of the set of users, the user included in the subset.

17. The non-transitory computer-readable medium of claim 16, wherein the instructions that cause the computing system to filter the updated user data comprise instructions that, when executed by the computing system, cause the computing system to: compare a difference between a user's current interest rate and a currently available interest rate to a first threshold; and/or compare a ratio between the user's current loan balance and a value of the user's home to a second threshold.

18. The non-transitory computer-readable medium of claim 16, wherein the analysis of user data of the set of users and the product data uses a machine learning model to calculate a likelihood that a user will accept an offer of a financial product.

19. A computing system comprising:
a processor; and
a memory storing instructions that, when executed by the processor, cause the processor to:
generate for display, in a graphical user interface, a plurality of fields providing a summary of user data, wherein the summary of the user data is generated based on a first dataset and a second dataset;
detect that the first dataset has been updated to form an updated first data set;
in response to the first dataset having been updated:
retrieve an updated second dataset from a data feed; and
generate updated user data based on the updated first data set and the updated second data set;
generate for display, in the graphical user interface, an updated plurality of fields providing a summary of the updated user data;
determine, based on the updated user data and product data from a product feed, that one or more attributes of a product match one or more attributes of the updated user data;
transmit a message to a user, the message identifying the product; and
update the graphical user interface to include an indication of the message.

20. The computing system of claim 19, herein the instructions that cause the processor to determine that one or more attributes of the product match one or more attributes of the updated user data comprise instructions that cause the processor to:
identify a set of users by filtering the updated user data based on one or more metrics; and
identify, based on an analysis of user data of the set of users and the product data, a subset of the set of users, wherein the analysis uses a machine learning model to calculate a likelihood that a user will accept an offer of a financial product.
